(19) United States
(12) Patent Application Publication
(10) Pub. No.: US 2011/0239108 A1
(43) Pub. Date: Sep. 29, 2011

(54) CONFIGURABLE DYNAMIC COMBINATION OF HTML RESOURCES FOR DOWNLOAD OPTIMIZATION IN SCRIPT BASED WEB PAGE

(75) Inventors: Brian Charles Blomquist, Lynnwood, WA (US); Vikas Ahuja, Sammamish, WA (US); Albert Shen, Redmond, WA (US); Christopher John Beiter, Seattle, WA (US)

(73) Assignee: MICROSOFT CORPORATION, Redmond, WA (US)

(21) Appl. No.: 12/732,857

(22) Filed: Mar. 26, 2010

(51) Int. Cl. G06F 17/00

(52) U.S. Cl. 715/235; 715/234

(57) ABSTRACT

One embodiment may be practiced computing environment including a web page server. The embodiment includes a method of optimizing delivering of web page content resources. The method includes referencing script source code to identify a web page content resource to be delivered to a web page client. A configuration file is referenced to determine that the identified resource should be combined with additional resources and sent as a single file to the web page client. The identified resource is combined with the additional resources into a single combined file. The single file is delivered to the web page client.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Computers being interconnected has allowed for computers to provide services to other computers. For example, a web server can provide content to clients. In particular, an internet client such as Internet Explorer® available from Microsoft Corporation of Redmond, Wash., can be used to access a web server. The web server can provide HTML code that defines how a web page should be displayed.

The HTML code may include text information for displaying text to a user at the internet client. The HTML code may also specify how the text should be displayed.

The HTML code may also define how images should be displayed in a web page, including such information as size and positioning of the images with respect to other content. The HTML code typically includes a reference to the location of the images themselves, such as a location on the web server or some other content repository where the images are stored.

The web server or other source may also provide executable script, such as Java script which may be executed at the internet client to enhance content display. Again, the HTML code will include a reference to the location to the script. Further, the web server or other source may deliver style sheets with additional general information about how a web page should be laid out and/or displayed.

Many modern web servers are designed to dynamically provide content. In particular, rather than simply storing HTML content pages, the web servers include a server application that generates HTML dynamically when a web page client requests content. In this way, the web page returned can be customized for the client. For example, it may be desirable to deliver different advertising content to an internet client located in Redmond, Washington than to an internet client located in Salt Lake City, Utah. A developer can generate script source code that can be executed at the web server that can include functionality for determining the location of an internet client (or any one or more of a number of other variables) and dynamically generate HTML content based on the determined location. This custom HTML content can then be sent to the internet client.

As noted, HTML pages will often reference a number of other resources. For example, an HTML page may reference several different graphical images that should be included when the web page is displayed. To obtain those graphical images, often an internet client must request each image individually. Each image request has session overhead that results in network traffic that does not include any actual image data that is part of the image itself. Thus, more images being requested results in more overhead data being sent, resulting in strains to network bandwidth.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment may be practiced computing environment including a web page server. The embodiment includes a method of optimizing delivering of web page content resources. The method includes referencing script source code to identify a web page content resource to be delivered to a web page client. A configuration file is referenced to determine that the identified resource should be combined with additional resources and sent as a single file to the web page client. The identified resource is combined with the additional resources into a single combined file. The single file is delivered to the web page client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an environment where web page content is delivered from a web page server to a web page client; and

FIG. 2 illustrates a method of optimizing delivering of web page content resources.

### DETAILED DESCRIPTION

Embodiments are directed to the use of a configuration data structure such as a configuration file that identifies sets of resources that should be combined into single files with each other. When one of the resources should be delivered to a client browser, the configuration file is consulted to determine that the resource is identified as one that should be combined into a single file with other resources. A web server then combines the resources, optionally caches the combined resource, and returns the resources, as a single file, to the client browser. The client browser may also receive HTML code (in some embodiments by using Cascading Style Sheets (CSS) style information) that indicates what portion of the single file should be used for proper rendering of web pages at a display at the client browser.

Web page developers often program using server side scripts for use with web content frameworks. For example, the ASP.net® framework available from Microsoft Corporation of Redmond Washington is a framework that can be used to provide content dynamically to web clients. In particular, web page developers can program scripts that are later executed at a server running a framework. As a result of executing the script, the framework generates HTML code that can be provided to a web client, where the HTML code can be used at the web client to display a web page.

Some embodiments described herein use a framework that has extended functionality. In particular, such a framework may include enhanced libraries that allow for, and direct the use of, configuration files that facilitate the framework combining a plurality of resources into a single file and that facilitate altering the form of HTML content generated. The single file can be downloaded to a web client. The altered HTML includes references, such as for example CSS references, so that appropriate portions of the single file are accessed and/or displayed so as to cause a web page to be displayed in a fashion originally intended by a web page developer.

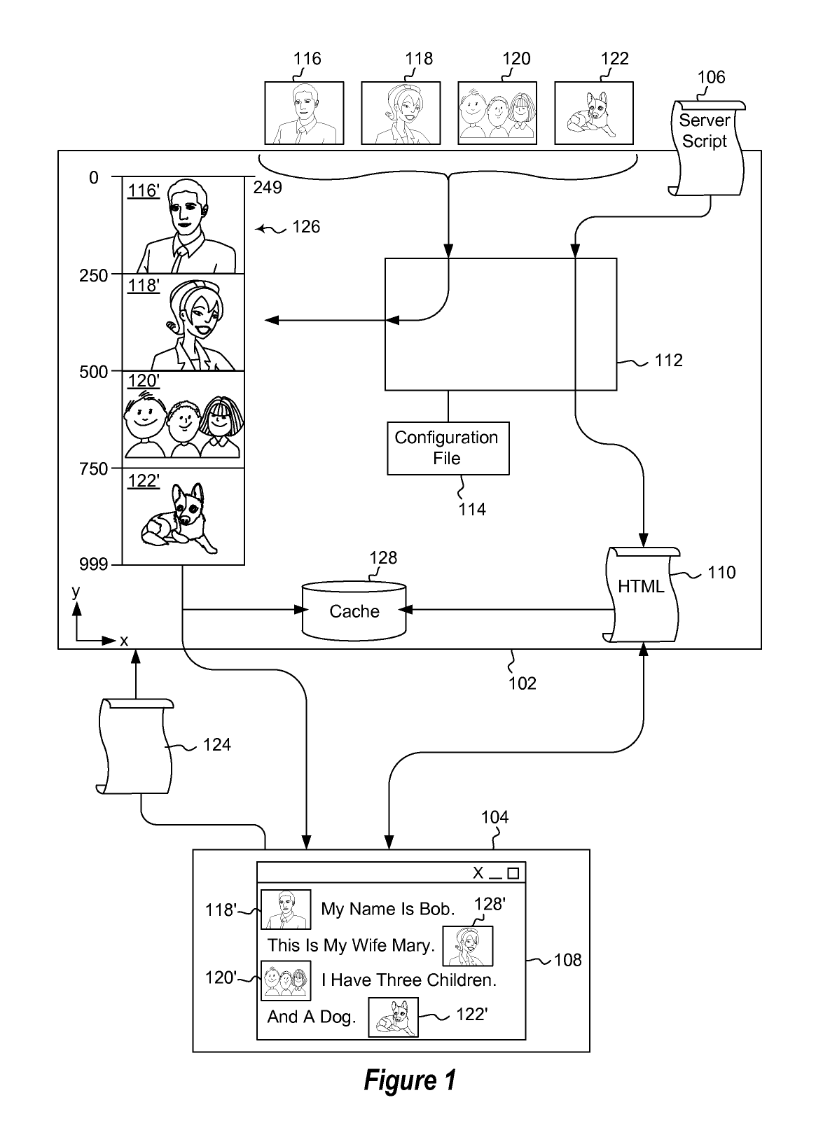

An illustrative embodiment is illustrated in FIG. 1. FIG. 1 illustrates an embodiment that allows for executing server scripts 106 generated by web page developers. The server scripts 106 may be created by a web page developer and used by a framework to dynamically create HTML web page documents. FIG. 1 illustrates a web page 108 rendered at the client 104. The web page 108 is rendered at the client 104 according to a layout described in an HTML document 110 created using the script and received by the client 104 from the server 106.

The HTML document 110 is created by a server module 112 based on execution of the server script 106 created by the web page developer. In the illustrated example, the sever module 112 is a specialized module that can use a configuration file 114 when the configuration files exists and is properly defined. The configuration file 114 defines individual resources that should be combined together into a single resource or file. For example, when the web developer creates the server script 106, the web page developer may indicate that various images 116, 118, 120, and 122 should be displayed in the web page 108 and indicate how the images 116, 118, 120, and 122 should be displayed (e.g. layout, size, resolution, etc). A determination may be made at the server 102 (e.g. by a developer or other individual, or by automated software at the server) that it is more efficient to deliver the images 116, 118, 120, and 122 as a single image so as to save on network bandwidth. Thus, the configuration file 114 can include an indication that images 116, 118, 120, and 122 should be combined into a single image file. Notably, this determination and the modification of the image file may be done outside of the scope of the creation of the server script 106 by the web page developer. Embodiments may be implemented where the server script 106 is created independent of any knowledge of what is defined in the configuration file 114. Further, the configuration file 114 can be modified without the need to modify any portion of the server script 106.

Because of the independence of the sever script 106 from the configuration file 114, the server script 106 can be run on servers which are not necessarily configured to use the configuration file 114. However, returning now to the description of the present example server 102, the client 104 may send a request 124 for the web page 108. In response, the server 102 accesses the server script 106 using the server module 112. The server script 106 includes an indication that images 116, 118, 120 and 122 should be included in the web page 108. The server module 112 consults the configuration file 114 and notes that the configuration file 114 indicates that images 116, 118, 120 and 122 should be combined into a single image file. As a result, the server module 112 stitches together images 116, 118, 120 and 122 into a single image 126.

The single image 126 includes four portions 116′, 118′, 120′ and 122′. Each of these four portions can be identified by their coordinates. For example, assume that each of the images 116, 118, 120 and 122 were 250 pixels wide×250 pixels long. The combined image is 250 pixels wide×1,000 pixels long. For rectangles, image coordinates are typically expressed as the top right and bottom left coordinates. Thus, in the example shown, the first portion 116′ has coordinates 249, 249. The second portion 118′ has coordinates 249, 499. The third portion 120′ has coordinates 249, 749. The fourth portion 122′ has coordinates 249, 999. In some embodiments, the single image 126 may be cached in a cache 128.

The sever module 112 further creates the HTML document 110 to display the portions based on the coordinates. For example, rather than creating an HTML document that references image 116, the server module will create an HTML document 110 that, such as for example by using as CSS that references images by coordinates, references image 126 and the coordinates 249, 249 for the portion 116′. Similar references will be made in the HTML document for the remaining portions 120′, 122′, and 124′. The HTML document 110 may be cached at the cache 128 (or another cache).

When the HTML document 110 is received at the client 104, rather than requesting each of the individual images 116, 118, 120 and 122 to display the web page, the client requests the single image 126 as indicated in the HTML document 110. The image portions 116′, 118′, 120′ and 122′ are then rendered as appropriate in the web page 108 displayed at the client 104.

At a server, combined resource can be cached after reading out from a configuration file so that subsequent requests for any of the resources that were combined into a combined file do not require the server to recreate the combined file again, which can be an expensive operation. For example, user 1 requests the resources, server scripts create the necessary combined file and then store the combined file in memory on the server. When user 2 requests the same web page, the server has already done the work of combining the images that are part of that web page. So instead of re-creating the combined file, the server can simply retrieve the newly combined file from a temporary cache and serve that combined file back to user 2.

In some embodiments a server-side cache can be date/time stamped so that any changes to the server-side configuration file or any of the individual image files that make up the combined file will force the server cache to be flushed and new versions of the combined images can then be created, stored and returned to the browser clients.

The combined resource file, once downloaded to the browser client, can be cached locally so that any subsequent requests to the same page or requests to other web pages that need any of the same resources that are part of the combined resource do not have to request the resources. They will instead just get a set of coordinates in the HTML/CSS returned from the server, and use a the local cached copy of the combined image file

Similar processing may be done for other resources as well. For example Java Scripts or CSS style files/resources may be combined into a single resource at the server 102 or from some other repository. The HTML 110 can be created at the server 102 to reference portions of the single Java Script file (which includes content from several Java script files) or the single CSS style sheet file (which includes content from several CSS style sheet files).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

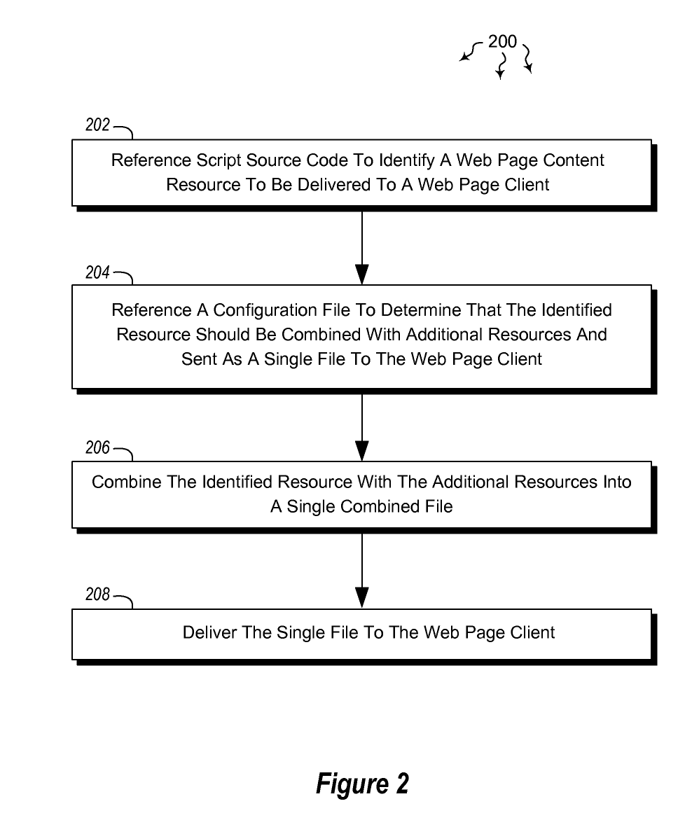

FIG. 2 illustrates a method 200 that may be practiced in computing environment including a web page server. The method includes acts for optimizing delivering web page content resources. The method includes referencing script source code to identify a web page content resource to be delivered to a web page client (act 202). For example, FIG. 1 illustrates a script 106 created by a web page developer and deployed to a server 102. The server script may identify resources, such as images, client side scripts, style sheets, etc. One of these resources may be identified.

The method 200 further includes referencing a configuration file to determine that the identified resource should be combined with additional resources and sent as a single file to the web page client (act 204). For example, the configuration file 114 may include an indication of resources that should be combined into a single file. In the example illustrated in FIG. 1, the configuration file 114 indicates that images 116, 118, 120, and 122 should be combined into a single file 126, which is also an image file with images 116, 118, 120, and 122 stitched together.

The method 200 further includes combining the identified resource with the additional resources into a single combined file (act 206). As noted and previously illustrated, an example is illustrated where images 116, 118, 120, and 122 are stitched into a single file.

The method 200 further includes delivering the single file to the web page client (act 208). FIG. 1 illustrates an example where the single file 126 is delivered to a web page client 104.

As illustrated in FIG. 1, embodiments of the method 200 may be practiced where the identified resource and the additional resources are all graphical images. Alternatively as illustrated in FIG. 2, embodiments of the method 200 may be practiced where the identified resource and the additional resources are all style sheet data. Another alternative is illustrated in FIG. 3, where the identified resource and the additional resources are all Java Script client code data.

The method 200 may further include determining a URI that requested that requested that the web page content resource to be delivered to a web page client. In some versions of this embodiment, determining that the identified resource should be combined with additional resources and sent as a single file to the web page client is dependent on the determined URI.

For example, the configuration file 114 may specify that a resource be combined with different resources, where the combination is dependent upon a referring URI. For example, different versions of the web page 108 may be created. For example a neighborhood web site may have one page that describes the family who lives in house 724 (URI: “/House724.aspx”) and has one set of images (including images 116, 118, 120, and 122) of all the members of the house including the dog that lives with the family. The neighborhood web site may have another page (URI: “/NeighborhoodDogs.aspx”) that describes all of the dogs in the neighborhood and has a stitched together image file of only the dogs (including 122 and other images not shown) in the neighborhood, but not the people since they are not needed for that page.

Embodiments may include a combined resource that includes images (or style sheets or scripts) for multiple web pages. When this file is cached by a browser client, any return visits to the same page or any other pages on the same site that need those same resources can then reference the local cached copy of the combined resources/images. The server will simply issue new HTML/CSS coordinates to display only the desired portion of the combined resource, thus freeing the browser from needing to make new requests for those same resources across multiple pages.

The method 200 may be practiced to further include modifying the configuration file without modifying the script source code. In particular, the script source code is not dependent on what is contained in the configuration file. The configuration file may indicate more or less than all of the resources (or one type of resources) are combined. When less than all resources are combined, other resources may be specified in the HTML 110 individually, or combined in a different set of resources in different single file.

The method 200 may further include automatically creating an HTML document based on the sever script. The server script may include a reference directly to the web page resource and creating the HTML document may include transforming the reference directly to the web page resource to a reference to the single file. For example, the server script 106 may reference image 116 directly, whereas the HTML document created includes a reference to the image 126. As noted, the single file includes content from a plurality of files. The HTML may also identify a portion of the single file corresponding to the web page resource. For example, the HTML document 110 may identify the portion 116′ (such as by identifying the coordinates 249, 249). The method may further include delivering the HTML document to the web page client. As illustrated in FIG. 1, the HTML document may be cached at the server 102 in the cache 128.

The method 200 may be practiced where the method is performed as a result of receiving a request for a web page from the client. For example, the client 104 may request, using a browser at the client 104, the web page 108. This may cause the single file 126 to be generated based on the information in the configuration file 114 and the HTML document 110 to be created based on the configuration file 114 and the server script 106. Embodiments may include caching the single combined file for subsequent requests for the web page. In particular, after the first request for a web page which causes the single file 126 to be created, subsequent requests for the web page 108 and the associated resources may be serviced by returning a cached copy of the single file 126.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer. Each of these is also an example of non-transitory computer readable media.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In computing environment comprising a web page server a method of optimizing delivering of web page content resources, the method comprising:
referencing script source code to identify a web page content resource to be delivered to a web page client;
referencing a configuration file to determine that the identified resource should be combined with additional resources and sent as a single file to the web page client;
combining the identified resource with the additional resources into a single combined file; and
delivering the single file to the web page client.

2. The method of claim 1 wherein the identified resource and the additional resources are all graphical images.

3. The method of claim 1 wherein the identified resource and the additional resources are all style sheet data.

4. The method of claim 1 wherein the identified resource and the additional resources are all Java Script client code data.

5. The method of claim 1 further comprising determining a URI that requested that requested that the web page content resource to be delivered to a web page client and wherein determining that the identified resource should be combined with additional resources and sent as a single file to the web page client is dependent of the determined URI.

6. The method of claim 1 further comprising modifying the configuration file without modifying the script source code.

7. The method of claim 1 further comprising automatically creating an HTML document based on the sever script, wherein the server script includes a reference directly to the web page resource and wherein creating the HTML document comprises transforming the reference directly to the web page resource to a reference to the single file, wherein the single file includes content from a plurality of files, and identifies a portion of the single file corresponding to the web page resource and delivering the HTML document to the web page client.

8. The method of claim 7, further comprising caching the HTML document at the server.

9. The method of claim 1, wherein the method is performed as a result of receiving a request for a web page from the client.

10. The method of claim 9 further comprising caching the single combined file for subsequent requests for the web page.

11. The method of claim 10, further comprising receiving a subsequent request for the identified resource or one of the additional resources from a client, and as a result, servicing the request by proving the single combined file from the cache.

12. In computing environment comprising a web page server, a computer readable medium having stored thereon computer executable instructions that when executed by one or more processors cause the following to be performed:
referencing script source code to identify a web page content resource to be delivered to a web page client;
referencing a configuration file to determine that the identified resource should be combined with additional resources and sent as a single file to the web page client;
combining the identified resource with the additional resources into a single combined file; and
delivering the single file to the web page client.

13. The computer readable medium of claim 12 wherein the identified resource and the additional resources are all graphical images.

14. The computer readable medium of claim 12 wherein the identified resource and the additional resources are all style sheet data.

15. The computer readable medium of claim 12 wherein the identified resource and the additional resources are all Java Script client code data.

16. The computer readable medium of claim 12 further comprising computer executable instructions for determining a URI that requested that the web page content resource to be delivered to a web page client and wherein determining that the identified resource should be combined with additional resources and sent as a single file to the web page client is dependent of the determined URI.

17. The computer readable medium of claim 12 further comprising computer executable instructions for automatically creating an HTML document based on the sever script, wherein the server script includes a reference directly to the web page resource and wherein creating the HTML document comprises transforming the reference directly to the web page resource to a reference to the single file, wherein the single file includes content from a plurality of files, and identifies a portion of the single file corresponding to the web page resource and delivering the HTML document to the web page client.

18. The computer readable medium of claim 12 further comprising computer executable instructions for caching the single combined file for subsequent requests for the web page.

19. The computer readable medium of claim 12 further comprising computer executable instructions for servicing requests from clients by proving the single combined file from a cache.

20. In computing environment comprising a web page server, a system for optimizing delivering of web page content resources the system comprising:
one or more processors:
one or more computer memories having stored thereon computer executable instructions that when executed by the one or more processors cause the following to be performed:
receiving a request for a web page from a web page client;
referencing script source code to identify a web page content resource to be delivered to a web page client as a result of the request for the web page;
referencing a configuration file to determine that the identified resource should be combined with additional resources and sent as a single file to the web page client;
determining a URI that requested the web page content resource to be delivered to a web page client and wherein determining that the identified resource should be combined with additional resources and sent as a single file to the web page client is dependent of the determined URI, such that different requests for the same web page originating from different URIs result in different resources being combined into different single combined files;
combining the identified resource with the additional resources into a single combined file; and
delivering the single file to the web page client.
